(19) United States
(12) Patent Application Publication
(10) Pub. No.: US 2005/0102276 A1
(43) Pub. Date: May 12, 2005

(54) Method and apparatus for case insensitive searching of ralational databases

(75) Inventors: Hung The Dinh, Austin, TX (US); Teng Hu, Austin, TX (US); Phong Anh Pham, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/703,614

(22) Filed: Nov. 6, 2003

(51) Int. Cl. G06F 17/30

(52) U.S. Cl. 707/3

(57) ABSTRACT

A method and apparatus for performing case insensitive searches of relational databases are provided. With the method and apparatus, an additional attribute value is provided for tables of a relational database that can be defined at table creation time and identifies portions of the tables of the relational database to be either case sensitive or case insensitive. Based on the setting of this attribute, the relational database engine is signaled to either perform case sensitive or case insensitive searches against the corresponding column of the table in the relational database. If the attribute is set, such that case insensitive searching of the column is signaled to the database engine, the database engine automatically generates either an uppercase or lowercase index corresponding to each value in the column. In response to a search request, the index is compared to a corresponding case version of the search term. If there is a match, the original entry in the column, i.e. the version of the value actually stored in the relational database table, is returned as a result of the search of the relational database.

### BACKGROUND OF THE INVENTION

1. Technical Field

The present invention is directed to an improved data processing system. More specifically, the present invention is directed to a method and apparatus for case insensitive searching of relational databases.

2. Description of Related Art

Relational databases are databases that use a database organization method that links files together as required. In non-relational systems, records in one file contain embedded pointers to the locations of records in another, such as customers to orders and vendors to purchases. These are fixed links set up ahead of time to speed up daily processing.

In a relational database, relationships between files are created by comparing data, such as account numbers and names. A relational system has the flexibility to take any two or more files and generate a new file from the records that meet the matching criteria.

Routine queries of relational databases often involve more than one data file. For example, a customer file and an order file can be linked in order to ask a question that relates to information in both files, such as the names of the customers that purchased a particular product.

In practice, a pure relational query can be very slow. In order to speed up the process, indexes are built and maintained on the key fields used for matching. Sometimes, indexes are created “on the fly” when the data is requested. Each table of a relational database may have a primary key, i.e. the field (column) in a database table that is indexed and maintains the main sequence of the table, and one or more foreign keys, i.e. a field in one table that is indexed in another table of the relational database. Searching of the tables of a relational database based on received queries may be performed based on these primary and foreign key indexes.

The queries performed on relational databases are case sensitive. That is, unless the search term case is matched exactly, an entry in the relational database will not be returned as a result. For example, if a column of a table in the relational database is used to store the first name of users, and a query is entered to find users whose first name is “James”, entries in the relational database of “james” or “JAMES” will not be matched because the case of the search term does not identically match the database values of “james” and “JAMES”.

In order to work around this problem with relational databases, additional columns or indices are added to the tables of the relational database in which the values are presented in both uppercase and lowercase. Thus, for example, if the values for the column “Name” are entered in all lowercase characters, or a combination of uppercase and lowercase characters, then an additional column may be added to the table that represents the entries in the “Name” column in all uppercase or all lowercase characters. Thereafter, any search queries received may have their search terms with regard to the column “Name” converted to all uppercase or all lowercase characters and the search performed on this additional column.

This workaround solution has a number of problems associated with it. The primary problems are that the workaround solution requires additional storage space for the additional column, additional forethought on the part of the creator of the relational database, and additional processing time to convert queries to a case that will be matched based on the additional column. Moreover, it can be seen that with tables having many columns, a large number of additional columns may be necessary in order to provide such search capabilities on each column of the relational database tables. This greatly increases the size of the relational database and increases the cost of storing the data of the relational database.

Thus, it would be desirable to have an improved method and apparatus for storing data in a relational database such that searching of the relational database may be performed in a case insensitive manner.

### SUMMARY OF THE INVENTION

The present invention provides a method and apparatus for performing case insensitive searches of relational databases. With the method and apparatus of the present invention, an additional attribute value is provided for tables of a relational database that can be defined at table creation time and identifies portions, e.g., columns, of the tables of the relational database to be either case sensitive or case insensitive. Based on the setting of this attribute, the relational database engine is signaled to either perform case sensitive or case insensitive searches against the corresponding column of the table in the relational database. Based on the setting of this attribute to be case insensitive, the relational database engine generates a case insensitive index, at the time the table is defined, for the portions of the relational database table that are to be searched with case insensitive searches and stores the case insensitive index in association with the relational database table.

As mentioned above, if the attribute is set, such that case insensitive searching of the column is signaled to the database engine, the database engine automatically generates either an uppercase or lowercase index corresponding to each value in the column. When a search of the table in the relational database is to be performed, this index value is compared to a corresponding case version of the search term provided in the search request that is received. If there is a match, the original entry in the column, i.e. the version of the value actually stored in the relational database table, is returned as a result of the search of the relational database.

Thus, with the present invention, the need for forethought by the creator of the relational database to provide additional columns to support various case-versions of search terms is eliminated. The present invention provides a convenient mechanism for a user to build case insensitive search queries against a relational database table. These and other features and advantages of the present invention will be described in, or will become apparent to those of ordinary skill in the art in view of, the following detailed description of the preferred embodiments.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary diagram of a distributed data processing system in which the present invention may be implemented;

FIG. 2 is an exemplary block diagram of a server computing device in which aspects of the present invention may be implemented;

FIG. 3 is an exemplary block diagram of a client computing device in which aspects of the present invention may be implemented;

FIG. 4 is an exemplary block diagram of a metadata data structure for tables of a relational database in accordance with one exemplary embodiment of the present invention;

FIG. 5 is an exemplary diagram of code defining the format of a table in a relational database in accordance with one exemplary embodiment of the present invention;

FIG. 6 is a flowchart outlining an exemplary operation of the present invention when creating a column in a relational database table in accordance with one exemplary embodiment of the present invention;

FIG. 7 is a flowchart outlining an exemplary operation of the present invention when performing a search of a relational database table in accordance with one exemplary embodiment of the present invention; and

FIG. 8 is a flowchart outlining an exemplary operation of the present invention when performing an insert/update operation on a relational database table in accordance with one exemplary embodiment of the present invention.

### DETAILED DESCRIPTION OF THE PREFERRED EMBODIMENT

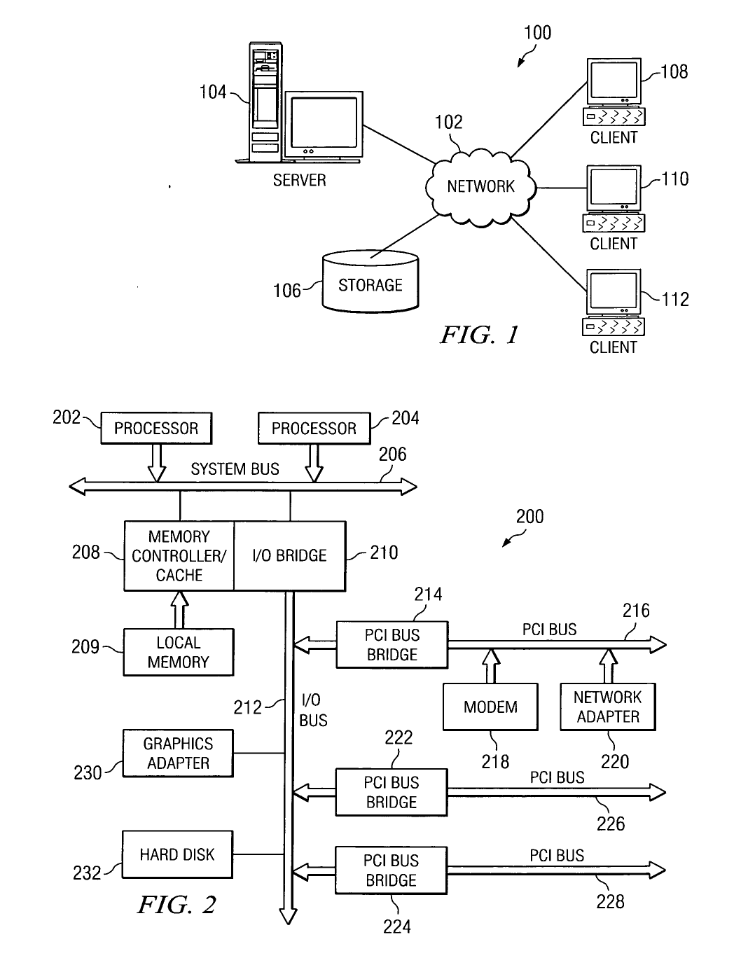

As mentioned above, the present invention provides a mechanism for performing case insensitive searching of a relational database. Since relational databases tend to be present in distributed data processing systems, the present invention is especially well suited for client-server type computing environments. Therefore, the following FIGS. 1-3 are intended to provide a context in which the description of the operations performed by the present invention may be understood. While the present invention, in a preferred embodiment, is implemented in a distributed data processing system such as that illustrated in FIGS. 1-3, the present invention is not limited to such and other computing environments in which relational databases may be utilized are intended to be within the spirit and scope of the present invention.

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

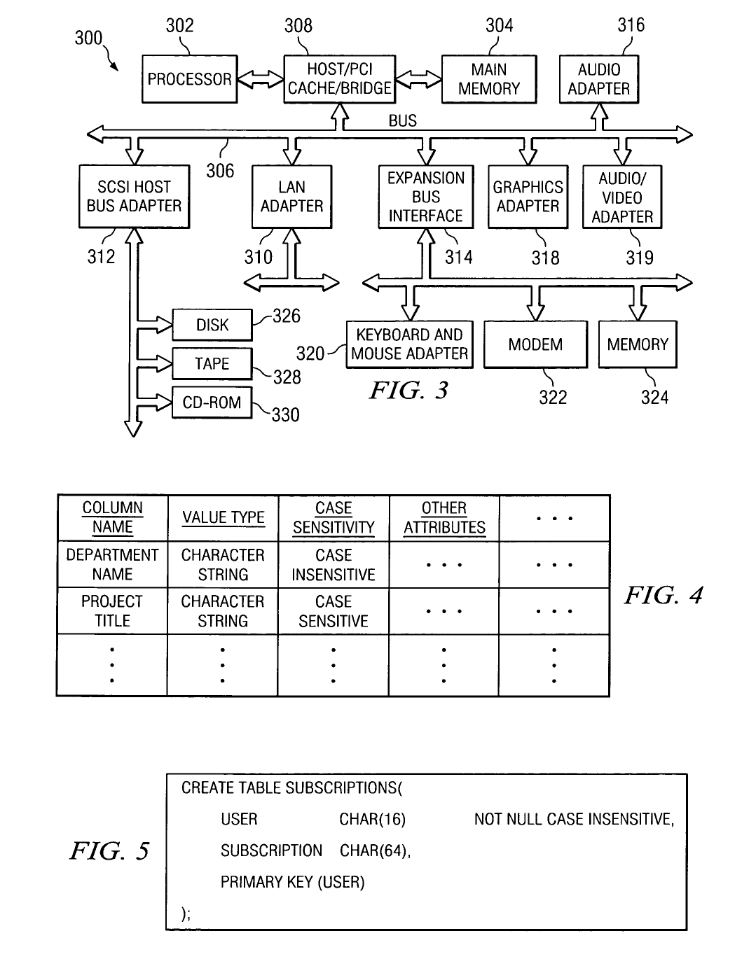

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component, connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented programming system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interfaces As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

The present invention provides a mechanism for permitting case insensitive searching of relational databases. With the present invention, assume that the server 104 provides a database engine, or database management system (DBMS), through which data may be stored in a relational database and searches of the relational database may be performed using the mechanism of the present invention. The actual data and metadata stored in the relational database may be physically stored in a storage device associated with the server 104, in a separate storage device such as storage device 106, or the like.

Queries may be sent to the server 104 from one or more client devices, such as client devices 108, 110 and 112. These queries may take many different forms and may be provided in different query languages. For example, the server 104 may provide a DB2 or Oracle database engine and the clients 108, 110 and 112 may send queries to the server 104 using the Structured Query Language (SQL).

With the present invention, the database engine of the server 104 is enhanced to include functionality to perform case insensitive searching of tables of the relational database in the manner described hereafter. As part of this functionality, the database engine provides an additional attribute for columns of the tables, or groups of elements, of the relational database that designates whether that column, or group of elements, of the relational database should be searched in a case sensitive mode or a case insensitive mode. The setting of this attribute in the table definition is determined during creation of the relational database tables and is used to generate metadata for the relational database table. This metadata is then consulted when a query is received, to determine whether a search of a column or group of elements in the relational database is to be performed in case sensitive or case insensitive mode.

Thus, for example, a “Subscription” table may be defined in the following manner:

```
CREATE TABLE SUBSCRIPTIONS(
    USER  CHAR(16) NOT NULL CASE INSENSITIVE,
    SUBSCRIPTION  CHAR(64),
);
```

The definition of the “Subscription” table includes the columns, or element groups, “USER” and “SUBSCRIPTION”. The “USER” column or group has been designated as a case insensitive column or group by the setting of a not null case insensitive attribute. As a result, when the database engine creates the subscription table using the definition set forth above, the metadata associated with the table will include an identifier indicating that the “USER” column or group is case insensitive. This indicator is used to switch search modes of the database engine from a default case sensitive search mode to a case insensitive search mode.

It should be noted that in the above table definition, the designation of the “SUBSCRIPTION” column or group does not include a setting of the case insensitive attribute to a non-null value. Thus, a default setting of the case insensitive attribute being set to null is utilized for the “SUBSCRIPTION” column or group. When the case insensitive attribute is null, case sensitive searching is performed with respect to that column or group.

As mentioned above, during table creation time, the relational database engine uses the table definitions to create tables in the relational database having the structure designated by the table definition. As part of this process, the present invention provides additional functionality in the relational database engine, and an additional attribute that may be specified in the table definition in association with the columns or groups of the table, to indicate when case insensitive searching of the column or group in the table is to be performed. Thus, when using the table definitions, the relational database engine generates a metadata data structure that identifies the structure of the table along with attributes of the table including the attributes of the columns or groups in the table.

An example block diagram of a metadata data structure generated by the relational database engine in accordance with one exemplary embodiment of the present invention is provided in FIG. 4. As shown in FIG. 4, the metadata data structure 400 includes one or more column name fields 410, an associated value type field 420 for the column name field, an associated case insensitive flag field 430, and other attributes 440 of the associated column. The value type field 420 identifies the type of value that may be used to designate the column name, e.g., char(16). The case insensitive flag field 430 indicates whether the associated column identified in field 410 is to be searched in a case sensitive manner or a case insensitive manner. This field is set to null as a default. If case insensitive searching of the column is to be performed, this field is set to a non-null value.

With the mechanisms of the present invention, when it is determined that case insensitive searching is to be performed, a case-biased version for each column entry in a column or group is generated and stored in association with the table as indices (referred to as case-biased indices) for the column or group entries. By the term “case-biased” what is meant is a version of an entry or a search term that has a predetermined pattern of character cases, e.g., uppercase or lowercase. For example, the predetermined pattern of character cases may be all uppercase characters, all lowercase characters, a predetermined pattern of uppercase and lowercase characters, or the like.

During the actual case insensitive search, as each column entry is considered by the searching mechanism of the relational database engine, the case-biased index is compared to a similarly case-biased version of the search term received in a query. If there is a match, the original column entry, i.e. the non-case-biased version of the column entry, is returned as a result of the search performed.

The case sensitive or case insensitive designation with regard to a column or group in a table influences the results returned by a search of the column or group. In addition, this case sensitivity or insensitivity also affects the column entries that may be added to a column or group within the table. Both of these influences will be illustrated with reference to the example table definition shown in FIG. 5.

FIG. 5 is an exemplary diagram of code defining the format of a table in a relational database in accordance with one exemplary embodiment of the present invention. As shown in FIG. 5, a table having the title “Subscriptions” is generated using this table definition code. The “Subscriptions” table has two columns, a first column entitled “USER” and a second column entitle “SUBSCRIPTION”. In the depicted example, the “USER” column has been designated as case insensitive.

Assume that the following insertion command is performed to insert a new value into the “Subscription” table:

insert into subscriptions(user, subscription) values
(‘jAmEs’, ‘db2’);

now, assume that a search of the table is to be performed to identify users named “james” and users named “James”. These searches may be performed using the following select statements:

select user from subscriptions where user=‘james’;

select user from subscriptions where user=‘James’;

Because the column “USER” has been designated as a case insensitive column, when these select statements are executed by the relational database engine, the search terms “james” and “James” are converted to a case-biased version, such as an all uppercase version “JAMES”. As each column entry in the column “USER” is searched by the search function of the relational database engine, the case-biased index is retrieved for each column entry in the “USER” column. Thus, for example, when the entry “jAmEs” is encountered during the search, its corresponding case-biased index “JAMES” is retrieved. A comparison of the case-biased index of the column entry and the case-biased version of the search term is made and, if there is a match, the column entry is added to a list of search results that are to be returned to the originator of the search query. This process repeats for each column entry.

In the examples given above, both of the select statements would result “jAmEs” being returned because the column “USER” has been designated as a case insensitive column. If the column “USER” had not been designated as case insensitive, neither of the select statements would have returned the “jAmEs” column entry because there is not an exact match between the search term and the “jAmEs” column entry.

Similar to the above, when a new column entry is being added to the table, the relational database engine first checks to ensure that there is not a duplicate column entry in the table. Specifically, the relational database engine checks to make sure there are no duplicate entries in the table having the same primary key. The present invention influences how this check is performed as described in the example hereafter.

Taking the above example table definition, as illustrated in FIG. 5, assume that the following insert operations are to be performed on the “Subscriptions” table:

```
Insert into subscriptions(user, subscription) values
    (‘jAmEs’, ‘db2’);
Insert into subscriptions(user, subscription) values
    (‘James’, ‘websphere’);
```

As part of the insertion operation, the relational database engine performs a search on the existing entries of the table to determine if there is an entry having a matching primary key. Because the primary key of the table is the “USER” column, and this column has been designated as a case insensitive column, the search that is performed is a case insensitive search such as that described above.

Thus, when executing the first insert operation, a case insensitive search of the table will result in no match being found because no column entries currently exist in the table. As a result of this insert operation, the table will consist of a single entry have the column entries “jAmEs” and “db2”.

Upon execution of the second insert operation, the case insensitive search of the table results in an error condition. This is because when the entry “jAmEs” is converted to a case-biased index, e.g., “JAMES”, and the search term “James” is converted to a similar case-biased version, e.g., “JAMES”, the case-biased index and the case-biased search term match. As a result, a duplicate entry having a duplicate primary key is determined to exist in the table. Accordingly, the second insertion will fail due to a duplicate primary key error.

Thus, the present invention provides a mechanism for searching relational databases in a case-insensitive manner that does not require additional versions of entries of the columns or groups of the table to be stored in the table in order to facilitate this case-insensitive searching. The case insensitive searching influences the results obtained from a search of the relational database as well as the entries that may be added to the relational database.

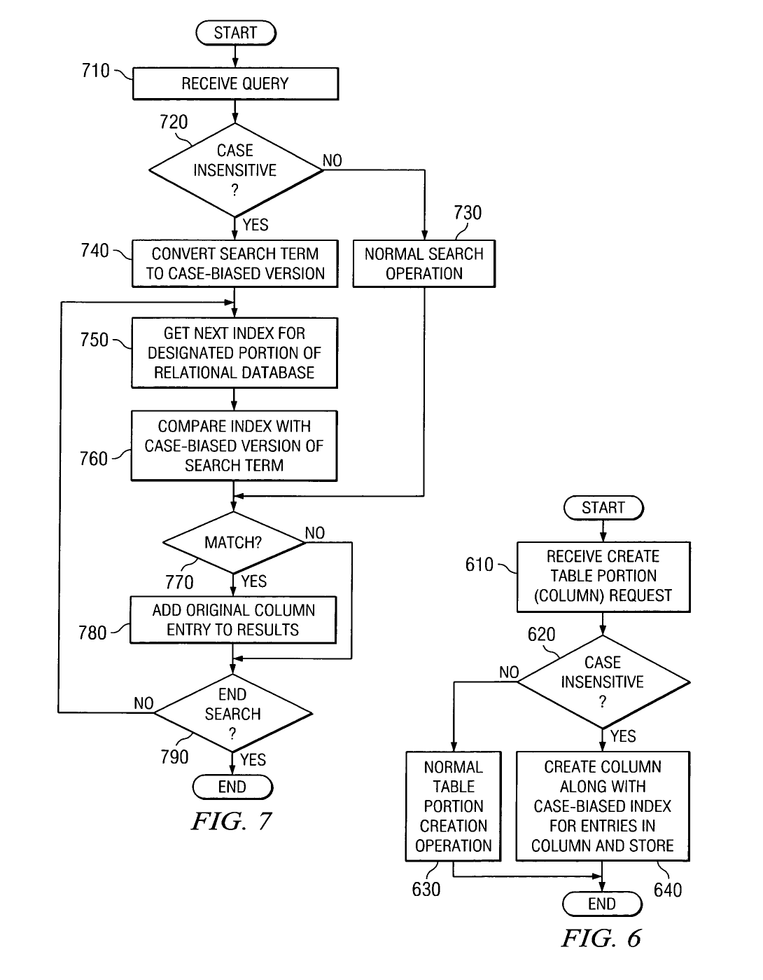

FIGS. 6-8 are flowcharts outlining exemplary operations of the present invention. It will be understood that each block of the flowchart illustrations, and combinations of blocks in the flowchart illustrations, can be implemented by computer program instructions. These computer program instructions may be provided to a processor or other programmable data processing apparatus to produce a machine, such that the instructions which execute on the processor or other programmable data processing apparatus create means for implementing the functions specified in the flowchart block or blocks. These computer program instructions may also be stored in a computer-readable memory or storage medium that can direct a processor or other programmable data processing apparatus to function in a particular manner, such that the instructions stored in the computer-readable memory or storage medium produce an article of manufacture including instruction means which implement the functions specified in the flowchart block or blocks.

Accordingly, blocks of the flowchart illustrations support combinations of means for performing the specified functions, combinations of steps for performing the specified functions and program instruction means for performing the specified functions. It will also be understood that each block of the flowchart illustrations, and combinations of blocks in the flowchart illustrations, can be implemented by special purpose hardware-based computer systems which perform the specified functions or steps, or by combinations of special purpose hardware and computer instructions.

FIG. 6 is a flowchart outlining an exemplary operation of the present invention when creating a portion of a relational database table, e.g., a column in a relational database table, in accordance with one exemplary embodiment of the present invention. As shown in FIG. 6, the operation starts by receiving a create column request for creating a column in a relational database table (step 610). A determination is made as to whether the column that is to be created has an attribute set identifying the column as a case insensitive search column (step 620). If not, a normal column creation operation is performed to create the new column in the relational database table (step 630). If the column is a case-insensitive search column, then the column is created and along with it, a case-biased index for each entry of the column is created and stored (step 640). The operation then ends.

FIG. 7 is a flowchart outlining an exemplary operation of the present invention when performing a search of a relational database table in accordance with one exemplary embodiment of the present invention. As shown in FIG. 7, the operation starts by receiving a query designating a portion of the relational database to be searched and a search term (step 710). This query may be an actual query received from a client device to retrieve entries from the relational database, may be an insertion operation for inserting a new entry into the relational database, or the like. The portion of the relational database may be, for example, the column of a table to be searched, e.g. “select user from subscriptions”

A determination is made as to whether the designated portion of the relational database is case insensitive or not (step 720). If the designated portion of the relational database is case sensitive, the search is performed in a normal fashion as previously described above (step 730). If the designated portion of the relational database is case insensitive, the search term is converted to a case-biased version (step 740).

The first/next case-biased index in the designated portion of the relational database is retrieved (step 750) and the case-biased index value is then compared to the case-biased version of the search term (step 760). A determination is made as to whether there is a match between the case-biased index and the case-biased version of the search term (step 770). If so, the original column entry corresponding to the case-biased index is added to a search result list (step 780).

Thereafter, or if there is not a match, a determination is made as to whether a search end criteria is met (step 790). This search end criteria may be that the last entry in the designated portion of the relational database has been processed, a matching entry is found, such as if the query is a insert operation, a requested number of matching results have been identified, or the like. If the search end criteria are met, the operation terminates. If the search end criteria have not been met, the operation returns to step 750 where the next case-biased index in the designated portion of the relational database is retrieved and the operation repeats.

Thereafter, the list of search results may be returned to the originator of the search query or other processing may be performed based on the results of the search. For example, if the query was an insert operation and the search results indicate a matching entry in the table, the further processing may include returning an error message indicating a duplicate entry in the table.

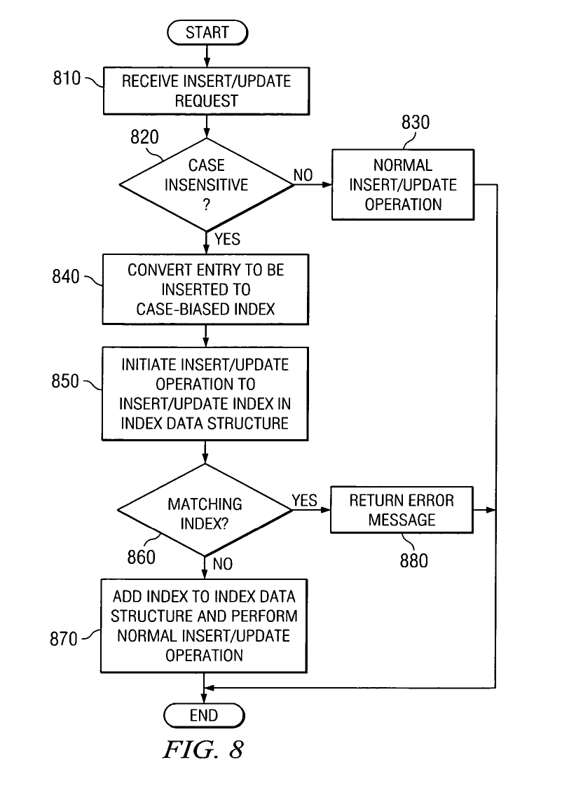

FIG. 8 is a flowchart outlining an exemplary operation of the present invention when performing an insert/update operation on a relational database table in accordance with one exemplary embodiment of the present invention. As shown in FIG. 8, the operation starts with the receipt of an insert/update request (step 810). A determination is made as to whether the portion of the relational database table, e.g., the column, to which the insert/update operation is to be performed is a case insensitive column (step 820). If the portion or column is not case insensitive, then a normal insert/update operation is performed (step 830).

If the portion or column is designated as being case insensitive, the value that is to be inserted/updated is converted to a case-biased index (step 840) and an insert/update operation is initiated to insert the index into the stored index data structure for the portion or column (step 850). A determination is then made as to whether there is already a matching index in the index data structure, i.e. a duplicate value (step 860). If not, then the index is added to the index data structure and the insert/update operation is performed in a normal manner (step 870). If there is a duplicate index in the index data structure, an error is returned (step 880). The operation then terminates.

Thus, the present invention provides an improved mechanism for searching relational databases. The present invention provides an additional attribute that may be set for portions of the relational database and functionality in the database engine to perform case insensitive searching functions based on the setting of this new attribute. In this way, a convenient mechanism for users to build case insensitive search queries against portions of a relational database is provided.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method, in a data processing system, for accessing entries of a relational database, comprising:
receiving a query designating a portion of the relational database to be searched and a search value to be matched;
determining if a case insensitive attribute for the designated portion of the relational database has been set; and
performing case insensitive searching of the portion of the relational database to identify entries matching the search value, if the case insensitive attribute is set for the designated portion of the relational database.

2. The method of claim 1, wherein performing case insensitive searching of the portion of the relational database includes:
retrieving a case-biased index for one or more entries in the designated portion of the relational database;
converting the search value to a case-biased version of the search value; and
comparing the case-biased index to the case-biased version of the search value.

3. The method of claim 2, further comprising:
adding an original entry, corresponding to the case-biased index, from the one or more entries, to a search results list if the case-biased index matches the case-biased version of the search value.

4. The method of claim 2, wherein the case-biased version of the search value is the search value in one of uppercase or lowercase characters.

5. The method of claim 4, wherein the case-biased index value is in one of uppercase or lowercase characters corresponding to the case-bias of the case-biased version of the search value.

6. The method of claim 2, further comprising:
generating an error message if the case-biased index matches the case-biased version of the search value.

7. The method of claim 1, wherein the query is an insert/update request for inserting/updating an entry in the relational database.

8. The method of claim 2, further comprising:
adding a new entry to the relational database if the case-biased index of the new entry does not match the case-biased index of another entry; and
adding the case-biased index of the new entry to an index data structure.

9. A computer program product in a computer readable medium for accessing entries of a relational database, comprising:
first instructions for receiving a query designating a portion of the relational database to be searched and a search value to be matched;
second instructions for determining if a case insensitive attribute for the designated portion of the relational database has been set; and
third instructions for performing case insensitive searching of the portion of the relational database to identify entries matching the search value, if the case insensitive attribute is set for the designated portion of the relational database.

10. The computer program product of claim 9, wherein the third instructions for performing case insensitive searching of the portion of the relational database include:
instructions for retrieving a case-biased index for one or more entries in the designated portion of the relational database;
instructions for converting the search value to a case-biased version of the search value; and
instructions for comparing the case-biased index to the case-biased version of the search value.

11. The computer program product of claim 10, further comprising:
instructions for adding an original entry, corresponding to the case-biased index, from the one or more entries, to a search results list if the case-biased index matches the case-biased version of the search value.

12. The computer program product of claim 10, wherein the case-biased version of the search value is the search value in one of uppercase or lowercase characters.

13. The computer program product of claim 12, wherein the case-biased index is in one of uppercase or lowercase characters corresponding to the case-bias of the case-biased version of the search value.

14. The computer program product of claim 10, further comprising:
instructions for generating an error message if the case-biased index matches the case-biased index of another entry.

15. The computer program product of claim 9, wherein the query is an insert/update request for inserting/updating an entry in the relational database.

16. The computer program product of claim 10, further comprising:
instructions for adding a new entry to the relational database if the case-biased index of the new entry does not match the case-biased index of another entry; and
instructions for adding the case-biased index of the new entry to an index data structure.

17. An apparatus for accessing entries of a relational database, comprising:
means for receiving a query designating a portion of the relational database to be searched and a search value to be matched;
means for determining if a case insensitive attribute for the designated portion of the relational database has been set; and
means for performing case insensitive searching of the portion of the relational database to identify entries matching the search value, if the case insensitive attribute is set for the designated portion of the relational database.

18. The apparatus of claim 17, wherein the means for performing case insensitive searching of the portion of the relational database includes:
means for retrieving a case-biased index for one or more entries in the designated portion of the relational database;
means for converting the search value to a case-biased version of the search value; and
means for comparing the case-biased index to the case-biased version of the search value.

19. The apparatus of claim 18, further comprising:
means for adding an original entry, corresponding to the case-biased index, from the one or more entries, to a search results list if the case-biased index matches the case-biased version of the search value.

20. The apparatus of claim 18, further comprising:
means for generating an error message if the case-biased index matches the case-biased index of another entry.

21. The apparatus of claim 18, further comprising:
means for adding a new entry to the relational database if the case-biased index of the new entry does not match the case-biased index of another entry; and
means for adding the case-biased index of the new entry to an index data structure.
